(19) United States
(12) Patent Application Publication
(10) Pub. No.: US 2026/0300487 A1
(43) Pub. Date: Oct. 1, 2026

(54) SYSTEMS AND METHODS FOR AUTONOMOUS SECURITY CONTROL TO PREVENT FILE EXECUTION BASED ON INCIDENT CLASSIFICATION CROWDSOURCING

(71) Applicant: Microsoft Technology Licensing, LLC, Redmond, WA (US)

(72) Inventors: Yaakov GARYANI, Raanana (IL); Roi Tzadok, Ramat Gan (IL)

(21) Appl. No.: 19/096,443

(22) Filed: Mar. 31, 2025

(51) Int. Cl. G06F 21/56; G06F 21/55

(52) U.S. Cl. CPC G06F 21/565; G06F 21/552

(57) ABSTRACT

Systems and methods are provided for autonomous security control to prevent file execution based on incident classification crowdsourcing. Incident classification data is received from multiple computing devices, each associated with an entity identifier, and is aggregated to generate a risk profile for each identified file. A risk score is assigned and dynamically adjusted based on factors including classification volume, source reputation, and timing. If the score exceeds a threshold, an execution prevention policy is generated and transmitted to devices for enforcement. Prevention may occur locally or remotely, with actions varying by subscription level and threat type.

### CROSS-REFERENCE TO RELATED APPLICATIONS

No cross-reference is presented at this time.

### FIELD OF THE INVENTION

The present invention relates to computer and network security systems, and more specifically, to techniques for preventing the execution of potentially malicious files using an autonomous control system that leverages incident classification data crowdsourced from multiple independent organizations.

### BACKGROUND

Organizations today rely heavily on endpoint security tools and network defense systems to prevent the execution of malicious files. Conventional approaches to threat detection are predominantly based on predefined heuristics, signature-based detection, or static rule sets derived from prior malware analyses. These systems often depend on a centralized threat intelligence repository and require significant lead time for threat researchers to discover, verify, and disseminate detection rules across deployed systems.

### SUMMARY

Aspects of the disclosure relate to methods, apparatuses, and/or systems for providing autonomous security control to prevent file execution based on incident classification crowdsourcing, the method comprising.

In some aspects, the techniques described herein relate to a computer-implemented method for autonomous security control to prevent file execution based on incident classification crowdsourcing, the method including: receiving, from multiple computing devices across different organizations, incident classification data corresponding to security events, the incident classification data including file identifiers and associated risk classifications; wherein a given file identifier identifies a given file; aggregating the received incident classification data; generating a risk profile for each identified file based on a number of independent risk classifications within the aggregated incident classification data indicating the file as malicious; assigning a risk score to each file, wherein the risk score is dynamically adjusted based on at least one of: a volume of independent organizations classifying the file as malicious, respective reputations of the organizations providing classifications, or a temporal distribution of classifications over time; determining whether the risk score for a given file exceeds a predefined execution prevention threshold; upon determining that the risk score exceeds the threshold for the given file, generating an execution prevention policy specifying that the given file should be blocked from execution across the computing devices in a participating organization; transmitting the execution prevention policy to the computing devices; and preventing execution of the given file on the computing devices subscribed to the security control system.

In some aspects, the techniques described herein relate to a method, further including updating the risk score dynamically based on newly received incident classification data.

In some aspects, the techniques described herein relate to a method, wherein the file identifier includes at least one of: a cryptographic hash of the file, a filename, file metadata, or a combination thereof.

In some aspects, the techniques described herein relate to a method, wherein the risk score is further adjusted based on the detection of common behavioral patterns among flagged files, and wherein the patterns relate to at least one of execution history, API calls, or associated process trees.

In some aspects, the techniques described herein relate to a method, wherein the execution prevention policy includes different levels of restriction based on the risk score, the levels including at least one of warning messages, quarantine actions, or complete execution blocks.

In some aspects, the techniques described herein relate to a method, further including applying a reputation weighting system that assigns different levels of influence to classifications provided by different organizations based on their historical accuracy in classifying security threats.

In some aspects, the techniques described herein relate to a method, wherein the risk score threshold is dynamically adjusted based on global threat intelligence feeds, and wherein execution prevention policies are modified in response to emerging attack trends.

In some aspects, the techniques described herein relate to a method, wherein an organization participating in the system can override the execution prevention policy based on local security policies and risk assessments.

In some aspects, the techniques described herein relate to a method, further including anonymizing incident classification data received from organizations.

In some aspects, the techniques described herein relate to a system for autonomous security control to prevent a security event based on incident classification crowdsourcing, including: memory storing computer program instructions; and one or more processors configured to execute the computer program instructions to: receive from a plurality of computing devices, incident classification data corresponding to at least one security event, the incident classification data including at least one event identifier and at least one associated risk classification; wherein a given event identifier is associated with a given security event; aggregate the received incident classification data; generate a risk profile for each security event based on a number of independent risk classifications within the aggregated incident classification data indicating the security event as malicious; assign a risk score to each security event, wherein the risk score is dynamically adjusted based on at least one of: a volume of independent sources classifying the security event as malicious, respective reputations of the sources providing classifications, or a temporal distribution of classifications over time; determine whether the risk score for a given security event exceeds a predefined execution prevention threshold; upon determining that the risk score exceeds the threshold for the given security event, generate an event prevention policy specifying that the given security event should be blocked from execution across the computing devices in a participating group of computing devices; transmit the execution prevention policy to the group of computing devices; and prevent execution of the given security event on the computing devices subscribed to the security control system.

In some aspects, the techniques described herein relate to a system, further configured to update the risk score dynamically based on newly received incident classification data.

In some aspects, the techniques described herein relate to a system, wherein the event identifier includes at least one of: a cryptographic hash associated with the event, an event name, event metadata, or a combination thereof.

In some aspects, the techniques described herein relate to a system, wherein the risk score is further adjusted based on the detection of common behavioral patterns among flagged events.

In some aspects, the techniques described herein relate to a system, wherein the execution prevention policy includes different levels of restriction based on the risk score, the levels including at least one of warning messages, quarantine actions, or complete execution blocks.

In some aspects, the techniques described herein relate to a system, further configured to apply a reputation weighting system that assigns different levels of influence to classifications provided by different sources based on their historical accuracy in classifying security threats.

In some aspects, the techniques described herein relate to a system, wherein the risk score threshold is dynamically adjusted based on global threat intelligence feeds, and wherein execution prevention policies are modified in response to emerging attack trends.

In some aspects, the techniques described herein relate to a system, wherein an source participating in the system can override the execution prevention policy based on local security policies and risk assessments.

In some aspects, the techniques described herein relate to a system, further including anonymizing incident classification data received from a given source.

In some aspects, the techniques described herein relate to one or more non-transitory computer storage media having computer executable instructions stored thereon which, when executed by one or more processors, cause the processors to execute a method for autonomous security control to prevent file execution based on incident classification crowdsourcing, including: receiving, from multiple computing devices across different organizations, incident classification data corresponding to security events, the incident classification data including file identifiers and associated risk classifications; wherein a given file identifier identifies a given file; aggregating the received incident classification data; generating a risk profile for each identified file based on a number of independent risk classifications within the aggregated incident classification data indicating the file as malicious; assigning a risk score to each file, wherein the risk score is dynamically adjusted based on at least one of: a volume of independent organizations classifying the file as malicious, respective reputations of the organizations providing classifications, or a temporal distribution of classifications over time; determining whether the risk score for a given file exceeds a predefined execution prevention threshold; upon determining that the risk score exceeds the threshold for the given file, generating an execution prevention policy specifying that the given file should be blocked from execution across the computing devices in a participating organization; transmitting the execution prevention policy to the computing devices; wherein the execution prevention policy includes different levels of restriction based on the risk score, the levels including at least one of warning messages, quarantine actions, or complete execution blocks; and preventing execution of the given file on the computing devices subscribed to the security control system.

In some aspects, the techniques described herein relate to one or more non-transitory computer storage media, further including updating the risk score dynamically based on newly received incident classification data; wherein the risk score threshold is dynamically adjusted based on global threat intelligence feeds; and wherein execution prevention policies are modified in response to emerging attack trends.

Various other aspects, features, and advantages will be apparent through the detailed description and the drawings attached hereto. It is also to be understood that both the foregoing general description and the following detailed description are exemplary and not restrictive of the scope of the disclosure.

### BRIEF DESCRIPTION OF THE FIGURES

FIG. 1 depicts an illustrative system for providing autonomous security control to prevent file execution based on incident classification crowdsourcing, in accordance with at least one embodiment;

FIG. 2 depicts an illustrative method for providing autonomous security control to prevent file execution based on incident classification crowdsourcing, in accordance with at least one embodiment; and

FIG. 3 depicts an example computer system on which systems and methods described herein are executed, in accordance with at least one embodiment.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION

In the following description, for the purposes of explanation, numerous specific details are set forth in order to provide a thorough understanding of the various embodiments. It will be appreciated, however, by those having skill in the art, that the embodiments may be practiced without these specific details, or with an equivalent arrangement. In other cases, well-known structures and devices are shown in block diagram form in order to avoid unnecessarily obscuring the embodiments.

A common technique used in traditional file execution prevention involves static reputation scoring. For example, files may be assigned a score based on their known publisher, hash-based whitelist or blacklist entries, or historical behavior across large populations of endpoints. In these systems, files that fall below a risk threshold may be blocked. However, these techniques are reactive and static, relying on historically gathered intelligence and lacking responsiveness to emerging or coordinated threats that exhibit no known indicators of compromise at the time of deployment.

Such systems are inherently limited in their ability to rapidly adapt to newly emerging threats—particularly those that are distributed across many organizations in the form of low-frequency, delayed-activation malware. Advanced threat actors often deploy file-based attacks across many independent targets in a way that avoids detection by any single security system, thereby undermining centralized threat detection strategies.

Further, traditional systems typically do not incorporate real-time incident feedback from diverse organizational environments. Even where incident data is collected, it is often siloed, proprietary, or non-standardized, preventing effective global correlation. Moreover, conventional reputation systems do not dynamically adjust trust levels based on the consensus of diverse entities or on the temporal characteristics of reported incidents.

Another critical limitation is the inability of traditional security controls to automatically evolve based on collective real-world observations. As a result, these systems often fail to prevent the execution of files that exhibit harmful behavior across disparate environments but do not yet appear in malware databases or signature repositories.

Still further, current security control systems may fail to account for false positives and inaccuracies in incident reporting. Without a robust mechanism to assess the credibility of threat intelligence sources, static models risk overreacting to anomalous or incorrect inputs. For example, a single misclassified file from a low-reputation source may result in unwarranted file blocking, causing operational disruption. Conversely, overly conservative systems may delay action until threats are confirmed via centralized analysis—by which time damage may already have occurred.

In light of the above, there is a need for a more dynamic, distributed, and autonomous approach to file execution control—one that leverages collective incident classification decisions from multiple independent organizations, entities, or sources, dynamically adjusts risk assessments based on the volume, source reputation, and timing of classifications, and automatically generates prevention policies to mitigate emerging threats before traditional systems are capable of responding.

To mitigate the problems described herein, various embodiments are described herein which provide solutions and, in some cases just as importantly, address problems overlooked (or not yet foreseen) by others in the field. Furthermore, some embodiments address problems that are nascent and will become much more apparent in the future should trends in industry continue as expected. Further, because multiple problems are addressed, it should be understood that some embodiments are problem-specific, and not all embodiments address every problem with traditional systems described herein or provide every benefit described herein. That said, improvements that solve various permutations of these problems are described below.

Embodiments of the systems and methods described herein provide a dynamic, autonomous security control system that prevents the execution of potentially malicious files based on incident classification data crowdsourced from multiple independent organizations or entities. Rather than relying solely on static signatures, heuristics, or centralized malware analyses, the system aggregates real-world incident classifications from distributed sources to generate a risk score for each file.

The system adjusts the risk score dynamically based on (i) the number of organizations that independently classify a file as malicious, (ii) the reputations of those organizations, and (iii) the timing and frequency of classifications. When the risk score for a file exceeds a configurable threshold, an execution prevention policy is generated and distributed to participating devices, specifying that the file should be blocked from execution.

The system optionally incorporates mechanisms for anonymizing contributor data, supports reputation-weighted scoring, and allows for local policy overrides. This architecture enables rapid, collective response to emerging threats without requiring centralized prior knowledge or analysis of the malicious payload, thus overcoming the latency and rigidity inherent in conventional malware prevention systems.

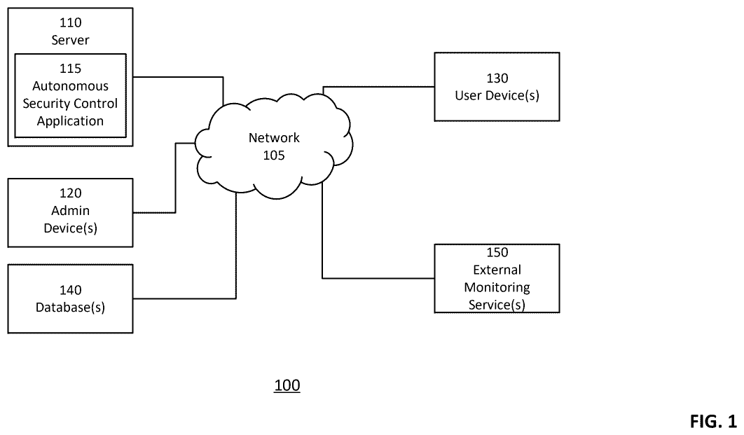

FIG. 1 depicts an illustrative system 100 for providing autonomous security control to prevent file execution based on incident classification crowdsourcing, in accordance with at least one embodiment. In some embodiments, various devices and applications described herein are configured to communicate via a network, e.g., network 105. In some embodiments, computing devices and servers described herein may communicate over network 105, which, in various embodiments, are any of a diverse range of networks, each tailored to specific needs: Local Area Networks (LANs) linking devices within a confined area such as a home or office; Wide Area Networks (WANs) connecting devices across larger geographical areas, such as cities or countries; Metropolitan Area Networks (MANs) serving as intermediaries, connecting LANs within a city or region; wireless networks; cellular networks; Storage Area Networks (SANs); and/or Virtual Private Networks (VPNs) secure data over public networks. In some embodiments, network 105 is any combination of the above, which is, for example, a combination of private and public networks.

In some embodiments, each of the elements of system 100 is or includes applications executed, for example, on respective computing systems, though this need not always be the case. In some examples, one or more of the applications is executed on a single computing system (which is not to suggest that such a computing system cannot include multiple computing devices or nodes, or that each computing device or node need be co-located; indeed, in some embodiments, a computing system including multiple servers that house multiple computing devices is operated, for example, by a single entity and the multiple servers may be distributed, e.g., geographically).

For example, in some embodiments, an entity includes, hosts, or otherwise executes, on a server or other computing system, e.g., server 110, one or more of the software components described herein. Moreover, in some examples, the entity also provides users access to applications and/or software components of server 110 on various user devices, as described herein. In some embodiments, access is provided, e.g., via a web-based application hosted by a computing system managed by or provisioned by the entity, or which communicates with such a computing system via one or more application programming interfaces (APIs). Accordingly, one or more of the devices, systems, and/or elements depicted herein communicate with one another via messages transmitted over network 105, such as, e.g., the Internet and/or various other local area networks. For example, in some embodiments, one or more applications communicate via messages transmitted over network 105.

Similarly, in some embodiments, administrators and/or other managers within an entity or organization use other client devices (e.g., Admin device(s) 120) to input data, change various user and/or system settings, etc., as described herein. For example, admin users, e.g., from cybersecurity, internal audit, compliance, or IT departments, are responsible for managing and/or configuring system 100. Accordingly, in some embodiments, admin users maintain and adjust the system, e.g., in response to various threats, as the organization evolves, etc.

In some embodiments, system 100 includes one or more client devices, such as, for example, user device(s) 130.

In various embodiments, user device(s) 130 represent computing systems operated by end users within a single organization, across multiple disparate and unrelated organizations, and/or by unaffiliated individual users. In some embodiments, these user device(s) 130 are communicatively connected to system 100 via a network 105. In various embodiments, user device(s) 130 include, e.g., a wide variety of computing devices, including but not limited to desktop computers, laptop computers, tablet devices, mobile phones, and wearable devices. In certain embodiments, user device(s) 130 comprise dedicated security devices, thin clients, or virtual machines operating within a local or cloud-based infrastructure. Additionally, in some embodiments, user device(s) 130 include servers, containerized workloads, or other back-end processing systems configured to execute or evaluate files within an enterprise environment.

In some implementations, user device(s) 130 run endpoint detection and response (EDR) agents, anti-malware clients, file execution monitors, or operating system-level security subsystems that facilitate communication with system 100. In some embodiments, these devices also generate or receive incident data, enforce execution prevention policies, and perform local analysis on files. In certain embodiments, user device(s) 130 are configured to submit incident classification decisions or related metadata—such as file identifiers, contextual alert data, or classification outcomes—to an autonomous security control (ASC) application 115 residing or otherwise executed on server 110, thereby participating in the crowdsourced incident intelligence network described herein.

In some embodiments, user device(s) 130 vary by deployment environment. For example, in enterprise contexts, such devices belong to managed device fleets subject to centralized administrative control. In contrast, in consumer or unmanaged environments, user device(s) 130 operate independently while still contributing to or receiving from the broader incident classification ecosystem. In each case, the device architecture and communication protocols are adapted, e.g., to suit the level of integration with system 100, the desired privacy constraints, and the available computational resources.

As noted above, in some embodiments, an autonomous security control (ASC) application 115 resides on or be executed by a server 110 and/or is configured to provide or otherwise perform the various security control features described herein. In some embodiments, the ASC application 115 is implemented, e.g., as a standalone software service, a containerized microservice, a set of cooperating modules, or part of a larger threat management platform. In various embodiments, ASC application 115 operates in a centralized cloud-based architecture, in a distributed network of cooperating servers, or in a hybrid deployment supporting edge-based processing.

In some embodiments, the ASC application 115 is configured to receive incident classification data from user device(s) 130 via network 105. This classification data includes, for example, file identifiers (e.g., cryptographic hashes, filenames, metadata), associated incident or alert context, and user-generated or automated determinations as to whether the corresponding incident is a true positive. In some implementations, ASC application 115 also receives periodic updates, telemetry, and/or classification feedback from multiple unrelated organizations or entities, enabling it to aggregate diverse and independently sourced threat intelligence.

Upon receipt of such data, in some embodiments, ASC application 115 executes logic to generate or update a risk profile for each identified file, as described in detail herein. In some embodiments, this process includes assigning and dynamically adjusting a risk score based on multiple parameters, including the volume of organizations reporting the file as malicious, the temporal distribution of such classifications, and the reputational weighting associated with the reporting entities. In some embodiments, the ASC application 115 applies thresholding logic to determine whether a given file should be designated for execution prevention.

In response to such determinations, in some embodiments, ASC application 115 generates one or more execution prevention policies. These policies specify, e.g., actions to be enforced by user device(s) 130 or intermediary systems, such as blocking file execution, quarantining the file, or issuing warnings to end users or administrators. In some embodiments, ASC application 115 also transmits these policies to affected or subscribing endpoints, optionally customizing policy enforcement based on device type, organizational policy, or contextual factors.

In certain implementations, ASC application 115 also supports anonymization of classification data to protect the identity and privacy of reporting entities, while preserving the integrity and utility of the aggregated intelligence. Additionally, in some embodiments, ASC application 115 exposes administrative interfaces or application programming interfaces (APIs) for monitoring, configuration, and integration with third-party systems.

Through these and other features, in various embodiments, ASC application 115 provides an adaptive, data-driven, and scalable security enforcement mechanism capable of autonomously responding to emerging threats in near real-time.

In various embodiments, one or more databases 140 are directly or indirectly connected to server 110 and are used to store data utilized or generated by the autonomous security control system. In some embodiments, database(s) 140 includes, e.g., structured, semi-structured, and/or unstructured data repositories and, in some embodiments, is implemented using relational databases, NoSQL databases, object stores, graph databases, or a combination thereof.

In some embodiments, database(s) 140 is configured to store a wide range of information, including but not limited to incident classification records, file identifiers (e.g., hashes, metadata, filenames, etc.), aggregated risk profiles, and dynamically updated risk scores. In some embodiments, database(s) 140 store anonymized incident reports submitted by user device(s) 130, reputation scores associated with contributing organizations, policy definitions generated by ASC application 115, and/or audit logs related to security decisions or policy enforcement actions.

In some embodiments, database(s) 140 support indexing and querying of historical classification trends, temporal analysis of incident data, and correlation of incidents across different entities. In some embodiments, access to database(s) 140 is governed by role-based permissions or access control layers to ensure data privacy and system integrity.

In various embodiments, external monitoring service(s) 150 include third-party systems, platforms, or service providers that supply supplemental threat intelligence, behavioral analytics, or contextual data to enhance the operation of the autonomous security control system. In some embodiments, these services are connected to server 110 directly or indirectly, for example, via network 105, and/or expose data through application programming interfaces (APIs), event feeds, or other standardized communication protocols.

In some embodiments, external monitoring service(s) 150 include one or more security vendors that provide malware signature databases, file reputation services, or real-time threat indicators. In some embodiments, such services offer additional metadata for files observed in the system, such as known publisher information, behavioral heuristics, prior compromise history, or known associations with malware campaigns.

In some embodiments, external monitoring service(s) 150 comprise vulnerability scanning systems, sandboxing environments, or automated detonation services capable of analyzing unknown files and reporting back observed behaviors. Additionally, in some embodiments, such services include telemetry platforms, security information and event management (SIEM) systems, or endpoint detection and response (EDR) solutions operated by other organizations.

In some embodiments, external monitoring service(s) 150 further provide access to global threat intelligence feeds, such as those maintained by industry consortiums, government agencies, or open-source threat intelligence communities. These services assist in calibrating or refining the risk scoring models used by ASC application 115, and/or serve as auxiliary inputs in determining whether a file meets criteria for execution prevention.

In certain implementations, data received from external monitoring service(s) 150 is integrated into database(s) 140 or directly utilized by ASC application 115 to enrich incident classification data, adjust reputation weightings, or inform the generation of execution prevention policies.

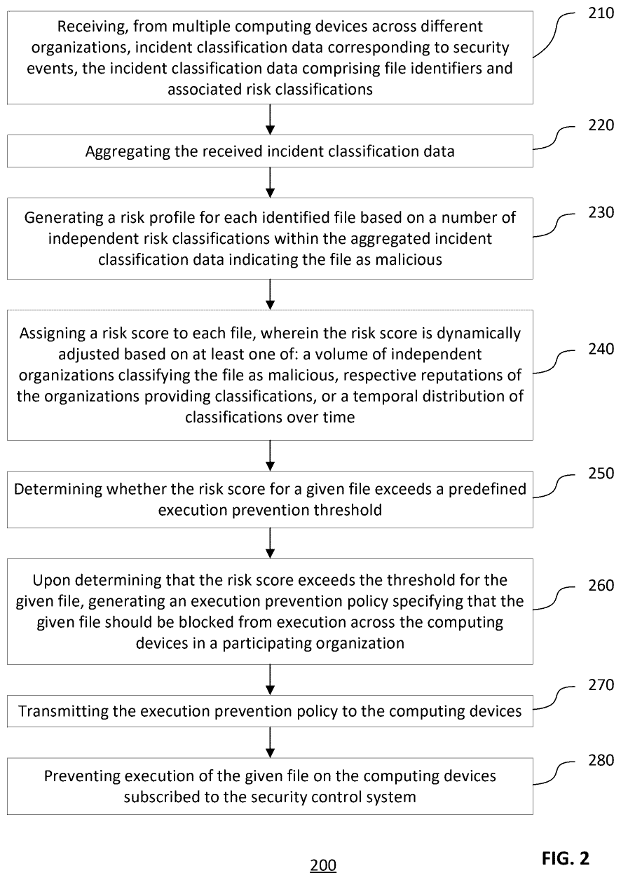

These and other features of system 100 will be further understood with reference to method 200 of FIG. 2, herein.

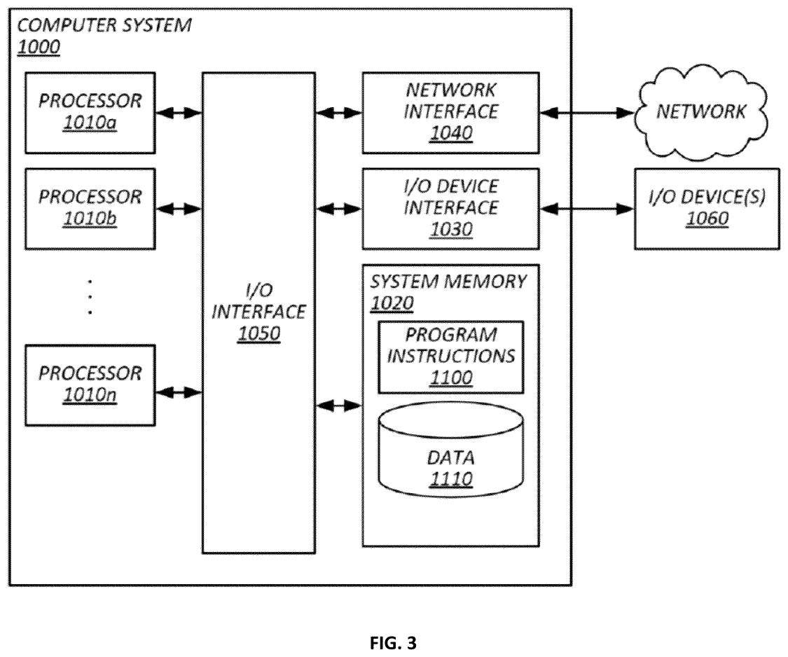

FIG. 2 depicts an illustrative method 200 for providing autonomous security control to prevent file execution based on incident classification crowdsourcing, in accordance with at least one embodiment. In various embodiments, method 200 is implemented by system 100, executing code in one or more processors therein. For example, in some embodiments, method 200 is performed on a computer (e.g., computer system 1000 of FIG. 3) having one or more processors (e.g., processor(s) 1010 of FIG. 4) and memory (e.g., system memory 1020 of FIG. 3), and one or more code sets, applications, programs, modules, and/or other software stored in the memory and executing in or executed by one or more of the processor(s).

Method 200 begins at step 210, when, in some embodiments, a processor receives incident classification data from a plurality of computing devices, e.g., associated with a plurality of entity identifiers, such as organization identifiers, user identifiers, personal identifiers, device identifiers, or combinations thereof. In some embodiments, an identifier, in this context, refers to a data element that, e.g., uniquely or pseudo-uniquely associates a device, user, organization, or other entity with submitted classification data. For example, in some embodiments, an organization identifier includes a company ID, a domain name, or a subscription ID tied to an enterprise security service account. In some embodiments, a device identifier includes a unique endpoint ID, MAC address, secure hardware identifier, or agent-issued GUID that distinguishes one computing device from another. In some embodiments, a personal identifier includes a user account name, email address, or an anonymized token that corresponds to an individual end user.

In some embodiments, various instances of incident classification data are received from computing devices associated with different organization identifiers, thereby enabling the system to evaluate cross-organizational consensus regarding potentially malicious files. In other embodiments, incident classification data is received, e.g., from a plurality of computing devices associated with a single organization identifier, such as from different departments or segments of a corporate network. In some implementations, incident classification data may also be received from unaffiliated individual user devices, each associated with a unique personal or device identifier but not associated with any organizational identifier. These variations enable the system to assess incident classifications across a broad spectrum of environments and trust models.

In some embodiments, each computing device is configured to submit classification data relating to a specific security event. In some embodiments, a given instance of incident classification data comprises, e.g., an identifier such as an event identifier (e.g., a file identifier that identifies a file associated with an event), and a risk classification associated with that file. In some embodiments, the file identifier includes, e.g., a cryptographic hash of the file, a filename, metadata associated with the file, or a combination thereof. In some embodiments, the classification is, e.g., a categorical or numerical label, such as “malicious,” “suspicious,” or “benign,” or a score representing a probability or confidence level of maliciousness.

In various embodiments, a security event refers to a system-detected or user-observed occurrence or activity that is potentially indicative of malicious, unauthorized, or otherwise suspicious activity within a computing environment. In various embodiments, a security event or activity serves as a foundational unit of analysis for risk assessment, threat detection, and policy enforcement within the autonomous security control system. In some embodiments, security events are generated, for example, by endpoint security agents, network monitoring systems, operating system kernel modules, intrusion detection systems (IDS), antivirus engines, file integrity monitors, or user-reported observations.

In some embodiments, a security event is associated with one or more entities, such as a file, process, user, device, or network connection. For example, in some embodiments, a security event corresponds to the execution of a file, the launch of a suspicious process, the elevation of privileges on a system, the detection of anomalous outbound traffic, or the access of sensitive data by an unauthorized user, etc. In some embodiments, the event is defined based on predefined detection rules or signatures; in other embodiments, it is triggered by heuristics, behavioral analytics, or machine learning models trained to detect deviations from established baselines.

In various embodiments, each security event is characterized, e.g., by a variety of attributes, including a timestamp, a source identifier (e.g., the device, user, or system where the event occurred), a description or event type (e.g., “file execution,” “registry modification,” “unauthorized login attempt”), and/or one or more associated identifiers. For example, in some embodiments, a file execution event includes a file identifier (e.g., SHA-256 hash), a process ID, the parent process, command-line arguments, and/or a user context. In some embodiments, a privilege escalation event includes, e.g., the original and resulting user privileges, the triggering process, and/or the affected system resources.

In some embodiments, a security event is accompanied, e.g., by telemetry data or forensic artifacts, such as memory snapshots, network packet captures, or execution traces. In various embodiments, these artifacts are analyzed, e.g., in conjunction with the event metadata to assess risk, determine root cause, or correlate across incidents.

In some embodiments, security events are classified, e.g., either manually by a user or automatically by a security system, as benign, suspicious, or malicious. In some embodiments, this classification is submitted to the autonomous security control system as part of incident classification data. Multiple security events involving the same entity—such as a file or IP address—are aggregated, e.g., over time to form a broader behavioral profile or to support a more robust risk score calculation. In certain implementations, a security event also serves as a trigger for generating a policy recommendation, updating a risk profile, or initiating enforcement actions such as file execution prevention.

In various embodiments, incident classification data refers to information submitted, e.g., by a computing device, security system, or user that reflects a determination—manual or automated—that a particular security event or object, such as a file, is associated with malicious or suspicious activity. The specific structure and content of incident classification data may vary depending on the implementation, source environment, and reporting mechanism.

In some embodiments, incident classification data includes, e.g., a file identifier and an associated risk classification. In some embodiments, the file identifier is, e.g., a cryptographic hash (e.g., SHA-256), a filename, a file path, metadata extracted from the file (e.g., publisher information, digital signature status, file size, etc.), or a combination thereof. In various embodiments, the risk classification is, e.g., categorical (e.g., “malicious,” “suspicious,” or “benign”) or numerical (e.g., a confidence score or probability value), and/or derived from user input, heuristic analysis, or automated threat detection systems.

In some embodiments, incident classification data is associated with a specific security event, such as a file execution, privilege escalation attempt, suspicious network connection, or abnormal system behavior, etc. The classification data in this context includes, e.g., a unique event identifier, event timestamp, involved process identifiers, associated file or executable, behavioral trace data (e.g., API calls or registry modifications), and/or a verdict or classification label (e.g., “confirmed true positive”), etc.

In some embodiments, incident classification data further includes contextual metadata such as, e.g., device identifier, user identifier, geographic location, operating system version, detection method (manual vs. automated), or alert source (e.g., EDR agent, antivirus engine, or SIEM system). This metadata assists in weighting or correlating classifications across diverse environments.

In some embodiments, incident classification data includes anonymized indicators contributed, e.g., by unaffiliated individual users or organizations with privacy constraints. For example, a personal device may submit an incident classification without revealing the user identity, device hostname, or organizational affiliation. In such embodiments, anonymization tokens or pseudonymous tags are used to maintain source differentiation without compromising privacy.

In some embodiments, incident classification data includes historical indicators, such as, e.g., whether the same file or event has previously been observed and how it was classified over time. This includes temporal markers (e.g., first seen, last seen), classification consistency (e.g., number of times classified as malicious), and/or trend data (e.g., increase in frequency of reports), etc.

In various embodiments, incident classification data is received in real time, batch form, or as part of a periodic reporting process, and/or is structured in accordance with predefined schemas, open standards (e.g., STIX/TAXII), or proprietary formats.

In various embodiments, risk profiles are generated and maintained not only for individual files but also for specific security events observed across participating devices and organizations. In some embodiments, a risk profile for a security event represents an evaluation of the event's likelihood of being associated with malicious activity, based on contextual factors, source information, and correlations with other known or suspected incidents.

In some embodiments, a risk profile is generated for a security event reported by an individual user device. For example, a file execution event, privilege escalation attempt, or suspicious process behavior observed on a single endpoint triggers the generation of an event-specific risk profile. In some embodiments, this profile includes attributes such as, e.g., the initiating file identifier, user or device context, timestamp, related process trees, system call traces, and any classification provided by the user or automated detection system.

In other embodiments, a risk profile is generated at the organizational level. For instance, an entity (e.g., an enterprise or business unit) may observe a coordinated sequence of events—such as lateral movement attempts, simultaneous endpoint infections, or repeated exploit patterns—and submit these observations as correlated incident data. In some embodiments, a risk profile for such an entity-level event includes aggregated signals from multiple endpoints, metadata about affected resources, alert classifications from internal systems, and/or historical trends observed within that entity, etc.

In some embodiments, risk profiles are generated from crowdsourced intelligence across multiple unrelated organizations, individual unaffiliated users, or a combination of both. In such cases, when similar or identical security events are observed in different environments, in some embodiments, the system associates these events and synthesizes a composite risk profile that reflects the broader threat landscape. In some embodiments, this composite profile considers the diversity of sources, consistency of observed behavior, and/or reputational weighting of the reporting parties.

In some embodiments, risk profiles are used to prioritize response actions, inform policy generation, or trigger further analysis. In certain implementations, risk profiles evolve dynamically as new data becomes available, and/or are linked to associated files, user behavior patterns, or threat campaign indicators.

In some embodiments, the incident classification data further includes contextual information such as an alert identifier, user action metadata, associated process activity, device identifiers, or timestamps. In some cases, the data is anonymized prior to receipt, or anonymized upon ingestion, to obscure or remove information that could be used to infer the identity of the submitting organization or user.

In some embodiments, the incident classification data is received, e.g., from multiple distinct entities within a single organization, such as separate departments, business units, or independently administered networks, each associated with a different internal identifier. In such cases, although the organization may be a single legal or administrative entity, the independent classification inputs are treated as originating from logically or operationally distinct sources.

In other embodiments, the incident classification data is received from user devices that are not affiliated with any organization, such as personal devices operated by individual users. In some embodiments, these unaffiliated devices participate in the system voluntarily or through integration with consumer-facing security products and submit classification data based on locally observed events. In certain embodiments, such data is tagged with anonymized user identifiers or region-specific metadata to allow for source differentiation while preserving individual privacy.

By accommodating incident classification data from both intra-organizational subdivisions and unaffiliated individual devices, embodiments of the system support a broader, more diverse threat intelligence model that is not limited to inter-organizational consensus alone.

In some embodiments, at step 220, the processor aggregates received incident classification data across multiple devices and organizations. In some embodiments, this aggregation involves organizing the classification data based on file identifiers such that all risk classifications associated with a given file are grouped together.

In some embodiments, aggregation involves de-duplicating redundant entries, normalizing disparate classification formats, or filtering incomplete submissions. In some embodiments, aggregation further includes correlating classification data across events that reference the same file, and/or associating that data with additional metadata such as submission time, source organization, or device type.

In some embodiments, the aggregation step enables creation of a comprehensive view of how a particular file has been classified across a distributed set of devices and organizations, which serve as input to subsequent steps in the method.

At step 230, in some embodiments, the processor generates a risk profile for each file identified during the aggregation of incident classification data. A risk profile, in this context, refers to a structured data object or record that consolidates classification intelligence and contextual metadata associated with a particular file. In some embodiments, the risk profile enables the system to track and evaluate the collective knowledge and/or behavioral indicators related to that file. In some embodiments, the risk profile includes a count of how many times a file has been classified as malicious by distinct sources, where such sources may be distinguished by organization identifiers, user identifiers, or anonymized tokens representing independently operating devices or entities.

In some embodiments, the risk profile also/alternatively includes a record of how many times the file has been classified as benign, suspicious, or unknown, allowing the system to evaluate the degree of consensus or disagreement among contributors. In some embodiments, temporal dimensions are tracked as well, including the timestamp of the first submission, the most recent classification, and the frequency with which new classifications have occurred within a given time window. For example, in some embodiments, a file that receives 15 malicious classifications from unrelated sources within a 2-hour period is treated differently than one that receives 15 malicious classifications spread out over several weeks.

In some embodiments, the risk profile stores file-specific metadata, including, e.g., the file's cryptographic hash (such as a SHA-256 or MD5 digest), filename and extension, digital signature attributes (such as publisher or certificate chain), file size, creation or modification time, and/or distribution characteristics, etc. In some embodiments, the risk profile also includes references to observed behavioral patterns, such as whether the file has been associated with launching child processes, making outbound network connections, modifying registry entries, or invoking operating system-level APIs known to be abused by malware. In some embodiments, the risk profile is represented as a structured record stored in a database and indexed by file identifier, enabling rapid lookup and updating as new incident classification data is received.

At step 240, in some embodiments, the processor assigns a risk score to each file, based at least in part on the contents of its risk profile. In some embodiments, a risk score refers to a numerical, categorical, or other value that quantifies the likelihood that the file is malicious or otherwise undesirable for execution on a device, e.g., within an organization, entity, or other environment. In various embodiments, the risk score is expressed, e.g., on a linear scale (e.g., 0 to 100), a logarithmic scale, or as a probability value (e.g., 0.0 to 1.0). In some embodiments, the calculation of the risk score considers several weighted factors, which are tunable via configuration or dynamically adjusted based on global system conditions. One such factor includes, e.g., the number of independent classifications received for the file, where independence may be defined in terms of unique organization identifiers, independently registered devices, or submission tokens assigned to unrelated user environments. For example, if the file has been classified as malicious by ten devices each affiliated with ten different organizations, in some embodiments, the weight of those submissions is higher than if all submissions came from a single organization.

In some embodiments, classifications are weighted according to the reputation of the submitting entity. In some embodiments, a reputation score is associated with each contributor and reflects, e.g., the historical accuracy, consistency, and/or validation rate of prior classifications. For instance, if an entity has previously submitted classifications that align closely with verified ground-truth labels, in some embodiments, its future submissions receive a proportionally greater influence in risk score computation. Another factor that is included in some embodiments is the temporal distribution of classifications. In some embodiments, a file that rapidly accumulates malicious classifications within a short time interval is interpreted as indicative of a spreading campaign, warranting more urgent response, whereas files with sporadic classifications over long durations is treated with greater skepticism.

In some embodiments, the risk score is further influenced by behavioral similarity between the file in question and other known malicious files. In some embodiments such similarity is assessed by comparing, e.g., execution traces, API call sequences, code signatures, or process trees. For example, if the file invokes the same set of system calls as previously flagged ransomware samples, in some embodiments, this pattern increases the assigned risk score. The risk score is recalculated periodically or upon the receipt of new classification data, and is stored as part of the file's record in the system database.

At step 250, in some embodiments, the processor determines whether the assigned risk score for a particular file exceeds a predefined execution prevention threshold. In some embodiments, this determination serves as a gating mechanism that dictates whether a policy should be generated to restrict the file's execution. In some embodiments, the execution prevention threshold is defined globally, such as a static numeric threshold established by system administrators (e.g., a file with a risk score above 75 is considered untrusted). In other embodiments, the threshold is dynamically adjustable based on system-wide risk levels, organizational policy profiles, or inputs from external threat intelligence feeds. For instance, if a widespread malware campaign is underway, in some embodiments, the system temporarily lowers the threshold to enable more aggressive blocking. Additionally, in some embodiments, the system considers contextual attributes such as, e.g., the role or classification of the affected device (e.g., production vs. development), the user's privilege level (e.g., administrator vs. guest), or the sensitivity of the data stored on the device.

In some implementations, thresholds vary across organizations or organizational units, such that a file is blocked in one enterprise but not another, based on the local security posture. In various embodiments, the decision logic also incorporates hysteresis or trend analysis, such that files with sharply rising risk scores are treated more conservatively than files whose scores remain static or decline. In certain embodiments, the result of this step is a binary decision (exceeds threshold or does not exceed threshold), while in others it results in an assignment to a policy tier (e.g., monitor, warn, block, quarantine), as described herein.

At step 260, in some embodiments, upon determining that the risk score for a file exceeds the applicable threshold, the processor generates an execution prevention policy specifying that the file should be blocked or otherwise restricted from execution. In some embodiments, an execution prevention policy includes a structured set of instructions or parameters that dictate, e.g., how and where enforcement should occur. In some embodiments, the policy identifies the file by one or more identifiers, such as, e.g., a SHA-256 hash, a specific filename, a digital certificate fingerprint, or a behavioral fingerprint derived from observed execution characteristics. In some embodiments, the policy specifies the enforcement action to be taken, such as, e.g., issuing a warning to the user, prompting for administrative approval, blocking the file's execution outright, or quarantining the file to a secure location.

In some embodiments, the policy includes conditions for scope and applicability, such as, e.g., restricting the enforcement to a particular set of devices, device types (e.g., Windows endpoints vs. Linux servers), user roles (e.g., standard users vs. privileged users), or geographies. In some embodiments, the policy also includes a confidence level or justification, such as a breakdown of risk score components or a summary of supporting evidence. In certain embodiments, the policy includes an expiration timestamp, after which the policy is no longer enforced unless refreshed. Some implementations also support the specification of override parameters, whereby an administrator at the organization level may choose to suppress or modify enforcement in accordance with internal risk assessments or regulatory constraints.

At step 270, the processor transmits the execution prevention policy to one or more computing devices that are subscribed to or otherwise participating in the autonomous security control system. In some embodiments, transmission occurs over a secure channel, such as, e.g., via TLS-encrypted APIs, message queues, or secure file distribution protocols. In some embodiments, the policy is pushed to the affected devices in real time, while in other embodiments, devices poll a central server or policy repository at regular intervals to retrieve updated policies.

In some embodiments, a policy message includes one or more cryptographic signatures, timestamps, or sequence numbers to ensure authenticity and to prevent replay or downgrade attacks. In certain implementations, the policy is tailored for specific devices or groups based on their configuration, location, usage patterns, or compliance requirements. For example, in some embodiments, a mobile device enrolled in a bring-your-own-device (BYOD) program receives a warning-level enforcement policy, whereas a domain-joined corporate workstation receives a hard block. In some embodiments, metadata describing the origin of the policy (e.g., issuing authority, policy version, justification) is included to support downstream auditability and traceability. In some embodiments, the devices receiving the policy store it locally in memory, on disk, or within a dedicated endpoint protection agent for use during runtime enforcement.

At step 280, in some embodiments, each computing device receiving the execution prevention policy applies the specified enforcement action to prevent execution of the identified file. In some embodiments, the enforcement mechanism is implemented at different levels of the device stack, including, e.g., user space (e.g., via a desktop security agent), kernel space (e.g., via driver-level process interception), or hardware-enforced environments (e.g., via trusted platform modules or secure enclaves). In some embodiments, when the file is accessed or attempted to be executed, the device checks the locally stored policy set and determines whether the file matches any entries. If a match is found and the policy mandates a block, in some embodiments, the system terminates the process, prevents process creation, or denies access permissions at the operating system level.

In another embodiment, if the policy specifies a warning-level action, the device prompts the user with an alert that includes information about the file's risk profile and the reason for the warning. In some embodiments, the user is offered options to continue, cancel, or escalate for administrative review. In some implementations, execution prevention is logged and reported back to the central server for purposes of analytics, feedback loops, and policy refinement. In some embodiments, the report includes, e.g., the file identifier, user and device context, enforcement outcome, and/or any override actions taken. In certain embodiments, organizations configure local policy engines to allow overrides or exceptions under predefined conditions, such as for trusted users, whitelisted applications, or forensic investigation workflows. This flexibility allows the system to maintain security while supporting operational continuity and organizational autonomy.

In some embodiments, execution prevention occurs remotely, such as through a cloud-based enforcement mechanism that intercepts and blocks access to the file at the network or storage layer before it reaches the endpoint device. For example, if the file is hosted on a cloud storage service or delivered via a web-based application, in some embodiments, the system integrates with a gateway, proxy, or access control API to prevent the file from being downloaded, opened, or executed. In other embodiments, prevention occurs locally on the computing device itself. In such cases, a locally installed enforcement module, such as an endpoint security agent, kernel-mode driver, or host-based intrusion prevention system (HIPS), is responsible for identifying policy-matching files at runtime and/or performing the prescribed enforcement action, such as blocking execution, alerting the user, or quarantining the file in an isolated directory.

In various embodiments, the level and type of execution prevention applied is determined in part by the subscription type associated with a particular device, user, or organization. For example, in a tiered service model, a basic subscription applies minimal enforcement actions such as user-facing warnings or passive logging, while a premium or enterprise subscription enables proactive prevention measures, e.g., including automated blocking, file isolation, or integration with incident response workflows. In some embodiments, the subscription level also determines whether enforcement is applied solely at the device level, at the network perimeter, or across cloud services and distributed infrastructure.

Additionally, in some embodiments, different subscription types support different levels of granularity in policy enforcement for various threat categories. For instance, in some embodiments, one tier provides general blocking of known malware based on aggregated classification data, while a higher tier enables fine-grained prevention based on emerging threat patterns, fileless attacks, ransomware behavior, or advanced persistent threats (APTs). In some embodiments, subscription-based controls also govern access to override capabilities, policy customization interfaces, and audit logging features associated with execution prevention actions.

The systems and methods described herein provide many real-world technical improvements over conventional file execution prevention and threat detection mechanisms. For example, traditional security systems often rely on static signature-based detection or centrally managed threat intelligence, which suffer from delays in identifying novel or emerging threats. In contrast, the described systems and methods introduce a dynamic, distributed approach by leveraging incident classification data crowdsourced from multiple independent sources, including different organizations and unaffiliated devices. This enables faster identification of malicious files based on real-time classification patterns observed across diverse environments, rather than relying solely on centralized threat research.

Another technical improvement lies in the system's ability to generate and update risk scores dynamically using multiple dimensions of input—such as the volume of independent malicious classifications, the reputational weighting of those sources, and the temporal velocity of incident reports. By incorporating a flexible, multi-factor risk scoring engine, the system enhances the accuracy and responsiveness of threat assessments. This architecture helps reduce both false positives (blocking benign files) and false negatives (failing to block malicious files), which are common challenges in static reputation-based or heuristic systems.

Another significant improvement is the system's adaptive execution prevention mechanism, which allows policies to be tailored based on the severity of the threat, the trust level of the source, and the type of subscription or enforcement tier. For example, basic subscriptions may issue warnings, while enterprise subscriptions may apply hard blocks or automated quarantines. This granularity in policy control, combined with the option for local or remote enforcement, provides organizations with more nuanced and context-aware security postures without compromising user experience or operational continuity.

Additionally, the system improves scalability and interoperability in distributed environments. It supports anonymized, privacy-preserving classification submissions from unrelated sources and integrates with cloud-based or on-device enforcement mechanisms. This flexibility allows threat intelligence and execution control to extend across heterogeneous systems, user populations, and infrastructures—enabling a collective, adaptive defense model that improves over time with each new contribution, rather than remaining fixed or reactive.

Some embodiments execute the above operations on a computer system, such as the computer system of FIG. 3, which is a diagram that illustrates a computing system 1000 in accordance with embodiments of the present techniques. In some embodiments, various portions of systems and methods described herein, include or are executed on one or more computer systems similar to computing system 1000. Further, processes and modules described herein are executed by one or more processing systems similar to that of computing system 1000.

In some embodiments, computing system 1000 includes one or more processors (e.g., processors 1010a-1010n) coupled to system memory 1020, an input/output I/O device interface 1030, and a network interface 1040 via an input/output (I/O) interface 1050. In some embodiments, a processor includes a single processor or a plurality of processors (e.g., distributed processors). In some embodiments, a processor is any suitable processor capable of executing or otherwise performing instructions. In some embodiments, a processor includes a central processing unit (CPU) that carries out program instructions to perform the arithmetical, logical, and input/output operations of computing system 1000. In some embodiments, a processor executes code (e.g., processor firmware, a protocol stack, a database management system, an operating system, or a combination thereof) that creates an execution environment for program instructions.

In some embodiments a processor includes a programmable processor. In some embodiments, a processor includes general or special purpose microprocessors. In some embodiments, a processor receiver instructions and data from a memory (e.g., system memory 1020). In some embodiments, computing system 1000 is a uni-processor system including one processor (e.g., processor 1010a), or a multi-processor system including any number of suitable processors (e.g., 1010a-1010n). In various embodiments, multiple processors are employed to provide for parallel or sequential execution of one or more portions of the techniques described herein. Processes, such as logic flows, described herein are performed by one or more programmable processors executing one or more computer programs to perform functions by operating on input data and generating corresponding output. In some embodiments, processes described herein are performed by, and apparatus are also implemented as, special purpose logic circuitry, e.g., an FPGA (field programmable gate array) or an ASIC (application specific integrated circuit). In some embodiments, computing system 1000 includes a plurality of computing devices (e.g., distributed computer systems) to implement various processing functions.

In some embodiments, I/O device interface 1030 provides an interface for connection of one or more I/O devices 1060 to computer system 1000. In some embodiments, I/O devices include devices that receive input (e.g., from a user) or output information (e.g., to a user). In some embodiments, I/O devices 1060 include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. In some embodiments, I/O devices 1060 are connected to computer system 1000 through a wired or wireless connection. In some embodiments, I/O devices 1060 are connected to computer system 1000 from a remote location. In some embodiments, I/O devices 1060 located on remote computer system, for example, are connected to computer system 1000 via a network and network interface 1040.

In some embodiments, network interface 1040 includes a network adapter that provides for connection of computer system 1000 to a network. In some embodiments, network interface 1040 facilitates data exchange between computer system 1000 and other devices connected to the network. In some embodiments network interface 1040 supports wired or wireless communication. In some embodiments, the network includes an electronic communication network, such as the Internet, a local area network (LAN), a wide area network (WAN), a cellular communications network, or the like.

In some embodiments, system memory 1020 is configured to store program instructions 1100 or data 1110. In some embodiments, program instructions 1100 are executable by a processor (e.g., one or more of processors 1010a-1010n) to implement one or more embodiments of the present techniques. In some embodiments, instructions 1100 include modules of computer program instructions for implementing one or more techniques described herein with regard to various processing modules. In some embodiments, program instructions include a computer program (which in certain forms is known as a program, software, software application, script, or code). In some embodiments, a computer program is written in a programming language, including compiled or interpreted languages, or declarative or procedural languages. In some embodiments, a computer program includes a unit suitable for use in a computing environment, including as a stand-alone program, a module, a component, or a subroutine. In some embodiments, a computer program corresponds to a file in a file system. In some embodiments, a program is stored in a portion of a file that holds other programs or data (e.g., one or more scripts stored in a markup language document), in a single file dedicated to the program in key, or in multiple coordinated files (e.g., files that store one or more modules, sub programs, or portions of code). In some embodiments, a computer program is deployed to be executed on one or more computer processors located locally at one site or distributed across multiple remote sites and interconnected by a communication network.

In some embodiments, system memory 1020 includes a tangible program carrier having program instructions stored thereon. In some embodiments, a tangible program carrier includes a non-transitory computer readable storage medium. In some embodiments, a non-transitory computer readable storage medium includes a machine-readable storage device, a machine-readable storage substrate, a memory device, or any combination thereof. In some embodiments, non-transitory computer readable storage medium include, e.g., non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. In some embodiments, system memory 1020 includes a non-transitory computer readable storage medium that has program instructions stored thereon that are executable by a computer processor (e.g., one or more of processors 1010a-1010n) to cause the subject matter and the functional operations described herein. In some embodiments, a memory (e.g., system memory 1020) includes a single memory device and/or a plurality of memory devices (e.g., distributed memory devices). In some embodiments, instructions or other program code to provide the functionality described herein are stored on a tangible, non-transitory computer readable media. In some cases, the entire set of instructions is stored concurrently on the media, or in some cases, different parts of the instructions are stored on the same media at different times.

In some embodiments, I/O interface 1050 is configured to coordinate I/O traffic between processors 1010a-1010n, system memory 1020, network interface 1040, I/O devices 1060, and/or other peripheral devices. In some embodiments, I/O interface 1050 performs protocol, timing, or other data transformations to convert data signals from one component (e.g., system memory 1020) into a format suitable for use by another component (e.g., processors 1010a-1010n). In some embodiments, I/O interface 1050 includes support for devices attached through various types of peripheral buses, such as a variant of the Peripheral Component Interconnect (PCI) bus standard or the Universal Serial Bus (USB) standard.

Embodiments of the techniques described herein are implemented using a single instance of computer system 1000 or multiple computer systems 1000 configured to host different portions or instances of embodiments. In some embodiments, multiple computer systems 1000 provide for parallel or sequential processing/execution of one or more portions of the techniques described herein.

Those skilled in the art will appreciate that computer system 1000 is merely illustrative and is not intended to limit the scope of the techniques described herein. In some embodiments, computer system 1000 includes any combination of devices or software that perform or otherwise provide for the performance of the techniques described herein. For example, in some embodiments, computer system 1000 includes or is a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. In some embodiments, computer system 1000 is also connected to other devices that are not illustrated, or operates as a stand-alone system. In addition, the functionality provided by the illustrated components, in some embodiments, are combined in fewer components or distributed in additional components. Similarly, in some embodiments, the functionality of some of the illustrated components is not provided or other additional functionality is available.

Those skilled in the art will also appreciate that while various items are illustrated as being stored in memory or on storage while being used, these items or portions of them are transferrable between memory and other storage devices for purposes of memory management and data integrity. Alternatively, in other embodiments some or all of the software components executes in memory on another device and communicate with the illustrated computer system via inter-computer communication. In some embodiments, some or all of the system components or data structures are stored (e.g., as instructions or structured data) on a computer-accessible medium or a portable article to be read by an appropriate drive, various examples of which are described above. In some embodiments, instructions stored on a computer-accessible medium separate from computer system 1000 are transmitted to computer system 1000 via transmission media or signals such as electrical, electromagnetic, or digital signals, conveyed via a communication medium such as a network or a wireless link. Various embodiments further include receiving, sending, or storing instructions or data implemented in accordance with the foregoing description upon a computer-accessible medium. Accordingly, in various embodiments, the present techniques are practiced with other computer system configurations.

In block diagrams, illustrated components are depicted as discrete functional blocks, but embodiments are not limited to systems in which the functionality described herein is organized as illustrated. Is various embodiments, the functionality provided by each of the components is provided by software or hardware modules that are differently organized than is presently depicted, for example such software or hardware may be intermingled, conjoined, replicated, broken up, distributed (e.g., within a data center or geographically), or otherwise differently organized. In some embodiments, the functionality described herein is provided by one or more processors of one or more computers executing code stored on a tangible, non-transitory, machine readable medium. In some cases, notwithstanding use of the singular term “medium,” the instructions are distributed on different storage devices associated with different computing devices, for instance, with each computing device having a different subset of the instructions, an implementation consistent with usage of the singular term “medium” herein. In some cases, external (e.g., third party) content delivery networks host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, Applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B may include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and may be implemented in the form of data that causes functionality to be invoked, e.g., in the form of arguments of a function or API call. To the extent bespoke noun phrases are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

While the systems and methods described herein have generally be described with respect to a single legacy language being translated to a modernized coding language (e.g., one-to-one translation of a first language to a second language), in various embodiments, the same processes may be implemented in a one-to-many framework. For example, in some embodiments, a user may indicate one or more second languages to which a first language is to be translated. Additionally or alternatively, in some embodiments, one or more translation recommendations may be provided (as described herein) for multiple translations. In either event, embodiments of the systems and methods described herein may be configured to process multiple translations, e.g., in parallel and/or in series (e.g., based on an identified priority), as described herein.

This written description uses examples to disclose the implementations, including the best mode, and to enable any person skilled in the art to practice the implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method for autonomous security control to prevent file execution based on incident classification crowdsourcing, the method comprising:
receiving, from multiple computing devices across different organizations, incident classification data corresponding to security events, the incident classification data comprising file identifiers and associated risk classifications;
wherein a given file identifier identifies a given file;
aggregating the received incident classification data;
generating a risk profile for each identified file based on a number of independent risk classifications within the aggregated incident classification data indicating the file as malicious;
assigning a risk score to each file, wherein the risk score is dynamically adjusted based on at least one of: a volume of independent organizations classifying the file as malicious, respective reputations of the organizations providing classifications, or a temporal distribution of classifications over time;
determining whether the risk score for a given file exceeds a predefined execution prevention threshold;
upon determining that the risk score exceeds the threshold for the given file, generating an execution prevention policy specifying that the given file should be blocked from execution across the computing devices in a participating organization;
transmitting the execution prevention policy to the computing devices; and
preventing execution of the given file on the computing devices subscribed to the security control system.

2. The method of claim 1, further comprising updating the risk score dynamically based on newly received incident classification data.

3. The method of claim 1, wherein the file identifier comprises at least one of: a cryptographic hash of the file, a filename, file metadata, or a combination thereof.

4. The method of claim 1, wherein the risk score is further adjusted based on the detection of common behavioral patterns among flagged files, and wherein the patterns relate to at least one of execution history, API calls, or associated process trees.

5. The method of claim 1, wherein the execution prevention policy comprises different levels of restriction based on the risk score, the levels comprising at least one of warning messages, quarantine actions, or complete execution blocks.

6. The method of claim 1, further comprising applying a reputation weighting system that assigns different levels of influence to classifications provided by different organizations based on their historical accuracy in classifying security threats.

7. The method of claim 1, wherein the risk score threshold is dynamically adjusted based on global threat intelligence feeds, and wherein execution prevention policies are modified in response to emerging attack trends.

8. The method of claim 1, wherein an organization participating in the system can override the execution prevention policy based on local security policies and risk assessments.

9. The method of claim 1, further comprising anonymizing incident classification data received from organizations.

10. A system for autonomous security control to prevent a security event based on incident classification crowdsourcing, comprising:
memory storing computer program instructions; and
one or more processors configured to execute the computer program instructions to:
receive from a plurality of computing devices, incident classification data corresponding to at least one security event, the incident classification data comprising at least one event identifier and at least one associated risk classification;
wherein a given event identifier is associated with a given security event;
aggregate the received incident classification data;
generate a risk profile for each security event based on a number of independent risk classifications within the aggregated incident classification data indicating the security event as malicious;
assign a risk score to each security event, wherein the risk score is dynamically adjusted based on at least one of: a volume of independent sources classifying the security event as malicious, respective reputations of the sources providing classifications, or a temporal distribution of classifications over time;
determine whether the risk score for a given security event exceeds a predefined execution prevention threshold;
upon determining that the risk score exceeds the threshold for the given security event, generate an event prevention policy specifying that the given security event should be blocked from execution across the computing devices in a participating group of computing devices;
transmit the execution prevention policy to the group of computing devices; and
prevent execution of the given security event on the computing devices subscribed to the security control system.

11. The system of claim 10, further configured to update the risk score dynamically based on newly received incident classification data.

12. The system of claim 10, wherein the event identifier comprises at least one of: a cryptographic hash associated with the event, an event name, event metadata, or a combination thereof.

13. The system of claim 10, wherein the risk score is further adjusted based on the detection of common behavioral patterns among flagged events.

14. The system of claim 10, wherein the execution prevention policy comprises different levels of restriction based on the risk score, the levels comprising at least one of warning messages, quarantine actions, or complete execution blocks.

15. The system of claim 10, further configured to apply a reputation weighting system that assigns different levels of influence to classifications provided by different sources based on their historical accuracy in classifying security threats.

16. The system of claim 10, wherein the risk score threshold is dynamically adjusted based on global threat intelligence feeds, and wherein execution prevention policies are modified in response to emerging attack trends.

17. The system of claim 10, wherein an source participating in the system can override the execution prevention policy based on local security policies and risk assessments.

18. The system of claim 10, further comprising anonymizing incident classification data received from a given source.

19. One or more non-transitory computer storage media having computer executable instructions stored thereon which, when executed by one or more processors, cause the processors to execute a method for autonomous security control to prevent file execution based on incident classification crowdsourcing, comprising:
receiving, from multiple computing devices across different organizations, incident classification data corresponding to security events, the incident classification data comprising file identifiers and associated risk classifications;
wherein a given file identifier identifies a given file;
aggregating the received incident classification data;
generating a risk profile for each identified file based on a number of independent risk classifications within the aggregated incident classification data indicating the file as malicious;
assigning a risk score to each file, wherein the risk score is dynamically adjusted based on at least one of: a volume of independent organizations classifying the file as malicious, respective reputations of the organizations providing classifications, or a temporal distribution of classifications over time;
determining whether the risk score for a given file exceeds a predefined execution prevention threshold;
upon determining that the risk score exceeds the threshold for the given file, generating an execution prevention policy specifying that the given file should be blocked from execution across the computing devices in a participating organization;
transmitting the execution prevention policy to the computing devices;
wherein the execution prevention policy comprises different levels of restriction based on the risk score, the levels comprising at least one of warning messages, quarantine actions, or complete execution blocks; and
preventing execution of the given file on the computing devices subscribed to the security control system.

20. The one or more non-transitory computer storage media as in claim 19, further comprising updating the risk score dynamically based on newly received incident classification data;
wherein the risk score threshold is dynamically adjusted based on global threat intelligence feeds; and
wherein execution prevention policies are modified in response to emerging attack trends.
